(19) United States
(12) Patent Application Publication
(10) Pub. No.: US 2026/0310864 A1
(43) Pub. Date: Oct. 8, 2026

(54) PRESSURE-DRIVEN ENERGY SOURCE AND PREDICTIVE CFD MODEL FOR RENEWABLE ROTOR SYSTEMS

(71) Applicant: Ali Zahedinejad, Shiraz (IR)

(72) Inventor: Ali Zahedinejad, Shiraz (IR)

(21) Appl. No.: 19/435,754

(22) Filed: Dec. 30, 2025

(30) Foreign Application Priority Data
Apr. 13, 2024 (US) 63/633705

(51) Int. Cl. G06F 30/28; G06F 113/06; G06F 119/06

(52) U.S. Cl. CPC G06F 30/28; G06F 2113/06; G06F 2119/06

(57) ABSTRACT

A computational and experimental framework is disclosed for designing and analyzing high-performance axial turbines. A predictive CFD tool is developed using corrected momentum equations in a rotating fluid domain, implemented through customized programming and solver modification. The corrected formulation enables accurate simulation of fluid dynamics, pressure fields, and torque generation in rotating turbine systems. Verification of the integrated CFD tool is performed through extensive testing on multiple turbine prototypes, demonstrating close agreement between simulated and measured rotational behavior. Using this validated methodology, an enhanced-power axial turbine is designed for power absorption from zero-flow condition. Generalized analytical formulas are also developed and validated to investigate various scales of enhanced-power axial turbine with different bearing friction for evaluating power extraction from different fluids under zero and non-zero flow conditions. The approach provides a systematic basis for developing next-generation high-efficiency turbines and advanced flow-interaction devices.

### CROSS-REFERENCE TO RELATED APPLICATIONS

This application claims priority to any provisional applications previously filed by the inventor relating to rotor system and renewable energy source.

### TECHNICAL FIELD

The present disclosure relates to axial turbines, analytical formulation, cooling systems, fluid machinery, improved CFD tool, renewable energy sources, and transportation vehicles.

### BACKGROUND OF THE INVENTION

According to Betz-limit and double-actuator-disc theory, there is an upper limit for the power coefficient of axial wind turbines as well as hydro-kinetic turbines. Betz-limit states that the maximum power coefficient of a wind turbine cannot exceed 0.593. Double-actuator-disc theory demonstrates that the maximum power coefficient of a wind turbine with two discs (two rows) is limited to 0.64. The present disclosure, with focus on experimentation for new axial turbine prototypes, overcomes the Betz-limit and limitations from double-actuator-disc theory on power coefficient of axial turbines. A CFD model was developed and an accurate predictive CFD tool was employed for design of efficient axial turbine prototypes. Validation of the predictive CFD tool for modeling rotating turbines in general was accomplished with clear experimental data in the literature, analytical case studies, and with fabrication and testing of special axial turbines.

### SUMMARY OF THE INVENTION

The disclosure provides axial turbine configurations capable of absorbing power under zero-flow conditions. In one embodiment, a turbine referred to as “ENH-UPT” employs two axial blade rows shaped to create coordinated circulation and controlled pressure reduction between the rows. This pressure-driven flow initiates and sustains turbine rotation in the absence of external freestream flow. The turbine design is developed and evaluated using integrated experimental testing and a CFD model that incorporates corrected energy-absorption terms for moving boundaries. The CFD tool is used for prediction, verification, and optimization of rotating turbine performance. The ENH-UPT configuration is scalable from small devices to multi-meter systems and may operate in various fluids, including air and water. Analytical formulations are provided for assessing turbine behavior across different scales, bearing-friction levels, and flow conditions, including both zero-flow and non-zero-flow environments.

### BRIEF DESCRIPTION OF THE DRAWINGS

FIG. 1: The initial version of the Ultra-Power Turbine (UPT) developed without the predictive CFD tool.

FIG. 2: The optimized UPT prototype developed using the predictive CFD tool.

FIG. 3: Validating the “Ultra-Power” designation. Comparison of experimental and predictive CFD simulation data for power coefficient against Tip-Speed Ratio (T.S.R).

FIG. 4: Using predictive CFD tool (ANSYS-FLUENT software with C-program) for prediction of power coefficient curves for various size Ultra-Power Turbines.

FIG. 5: Drawing for ENH-UPT prototype illustrating rotor assembly. The ENH-UPT prototype has 33 cm diameter.

FIG. 6: The Zero-Turbine prototype tested under negligible shaft torque in external wind flow.

FIG. 7: Rotational speed against flow speed for ENH-UPT rotor prototype in uniform wind flows.

FIG. 8: Power coefficient against tip-speed ratio for ENH-UPT rotor prototype in uniform wind flows.

FIG. 9: Predictive CFD simulation and analytical study of ENH-UPT performance under zero-flow conditions, showing optimum torque-path trajectory.

FIG. 10: Predictive CFD simulation for ENH-UPT in water including cavitation.

FIG. 11: Flow-chart indicating major steps in verification of the momentum-correction UDF and predictive CFD model. Multiple axial-turbine prototypes were fabricated and tested to establish generality of the method.

FIG. 12: Depicts the internal structure of a low-friction spindle. The spindle housing (32) is constructed from PLA, the shaft (33) from stainless steel, and the five-blade 7.0 cm-diameter propeller (30) is fabricated using FDM technology and mounted inside the spindle.

FIG. 13: Absorbed power for the Ultra-Power Turbine at various tip-speed ratios and airflow velocities, corresponding to the setup of FIG. 12.

FIG. 14: The zero-power air-cooling unit. The system employs a series-coupled set of ENH-UPT turbines.

### DETAILED DESCRIPTION

### A. Ultra-Power Turbine (UPT)

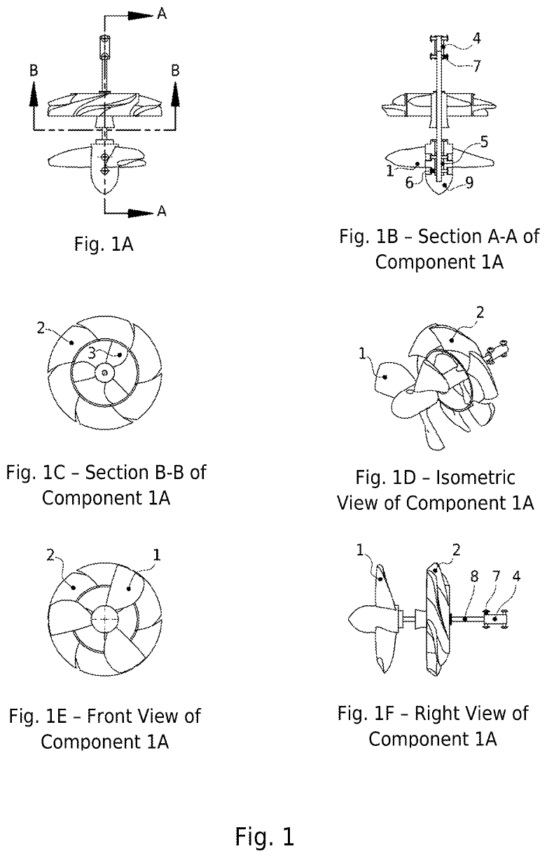

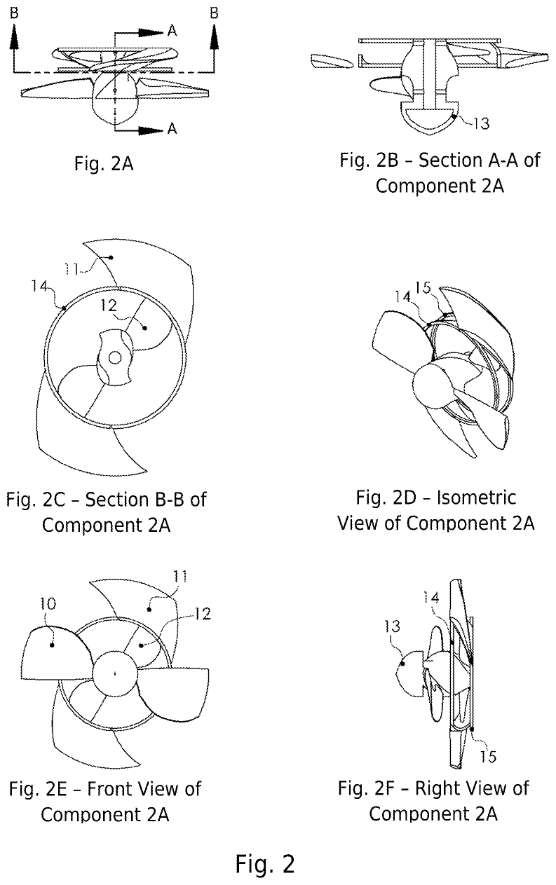

The Ultra-Power Turbine represents one of the primary validation platforms for the corrected momentum-equation User-Defined Function (UDF) implemented within a rotating fluid domain. The predictive CFD tool provides major advantages in the design of turbines exhibiting unusually high power-coefficients. To demonstrate the capabilities of the predictive CFD tool, an experimental program was conducted on a small-scale UPT composed of a primary two-bladed row and a secondary mixed four-bladed row. The initial version of the Ultra-Power Turbine (UPT) is illustrated in FIG. 1, with diameter 7.5 cm. The small-cale UPT as illustrated in FIG. 2, has made by PLA with 14.7 cm diameter.

FIG. 1: The initial version of the Ultra-Power Turbine (UPT) developed without the predictive CFD tool.

FIG. 2: The optimized UPT prototype developed using the predictive CFD tool.

The elements in FIG. 1 are: Frontal-blades (1), Mixed-row blades (2, 3), Shaft coupling (4), Connector (5), Front fastener (6), Rear fastener (7), Shaft (8) and Turbine hub (9). The elements of Ultra-Power Turbine in FIG. 2 are: Frontal-blades (10), Mixed-row blades (11, 12), Turbine hub (13), Frontal rotor ring (14) and Rear rotor ring (15).

The UPT is a horizontal-axis wind turbine configured to create controlled total-pressure variation within the rotor passages, thereby increasing local kinetic energy exchange and enhancing aerodynamic power absorption. The optimized UPT (FIG. 2) exhibits substantially higher angular velocity and power extraction relative to early versions (FIG. 1) designed without CFD assistance.

### B. Experimental Characterization of UPT

Experimental assessment relied on a combination of aerodynamic and electromechanical measurement methods. A calibrated five-blade propeller with a known performance curve was mechanically coupled to the UPT to generate predictable resistive torque. A low-friction spindle with tightly controlled clearances was fabricated, and a cubic algebraic model was developed to represent spindle frictional power and propeller aerodynamic resistance.

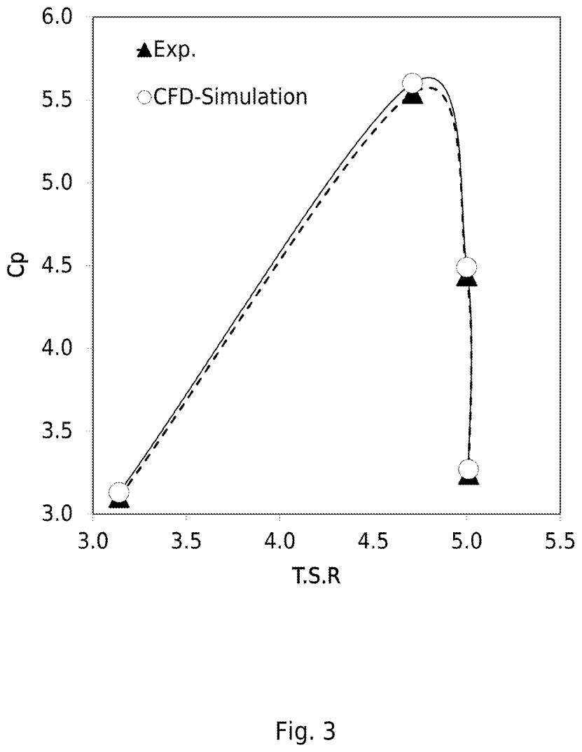

A laboratory power supply and an electric motor were used to determine propeller aerodynamic load in stationary air. This procedure enabled direct measurement of the UPT power coefficient, which reached a maximum value of 5.54, validating the “Ultra-Power” designation (FIG. 3). Early versions of the turbine, designed without CFD optimization, showed coefficients below 1.0.

### C. Full-Scale Ultra-Power Turbine Design

FIG. 2 provides an overview of the full-scale UPT rotor. The frontal blades (10) and mixed-row blades (11, 12) assemblies are coupled through cylindrical hubs. External blade pitch varies continuously from 0 degrees at the blade tips to approximately 45 degrees at the blade roots. Mixed-row blades (11, 12) located inside the rotor rings (14, 15) exhibit smooth pitch transitions to maintain aerodynamic continuity.

### D. Predictive CFD Simulation for Characterizing Full-Scale Ultra-Power Turbine

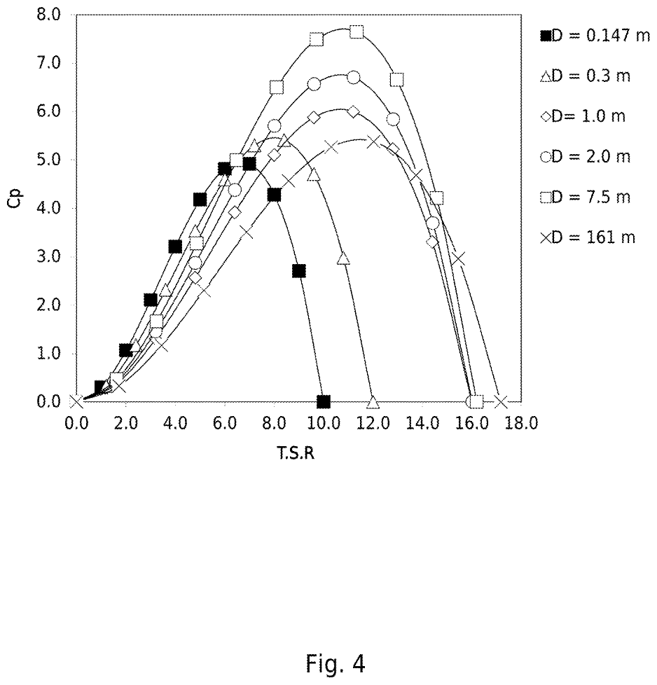

Results of CFD modeling with UDF and ANSYS-FLUENT software for Ultra-Power Turbine with different diameters were presented in FIG. 4. Simulation using predictive CFD tool illustrated decrease in the total pressure of air between two rows of rotor (FIG. 2). The power coefficient is the ratio of absorbed power to the flow kinetic energy toward the turbine area. Based on CFD simulations for the investigated sizes, the optimum power coefficient corresponds to UPT with 7.5 m diameter where power coefficient reaches to 7.64 (FIG. 4). In the simulations air density was 1.225 kg/m³ and the turbine was modeled at sea level. The turbulence intensity was 10.5 percent and the free stream velocity was 7.5 m/sec.

FIG. 3: Validating the “Ultra-Power” designation. Comparison of experimental and predictive CFD simulation data for power coefficient against Tip-Speed Ratio (T.S.R).

FIG. 4: Using predictive CFD tool (ANSYS-FLUENT software with C-program) for prediction of power coefficient curves for various size Ultra-Power Turbines.

### E. Enhanced-Ultra-Power Turbine (ENH-UPT)

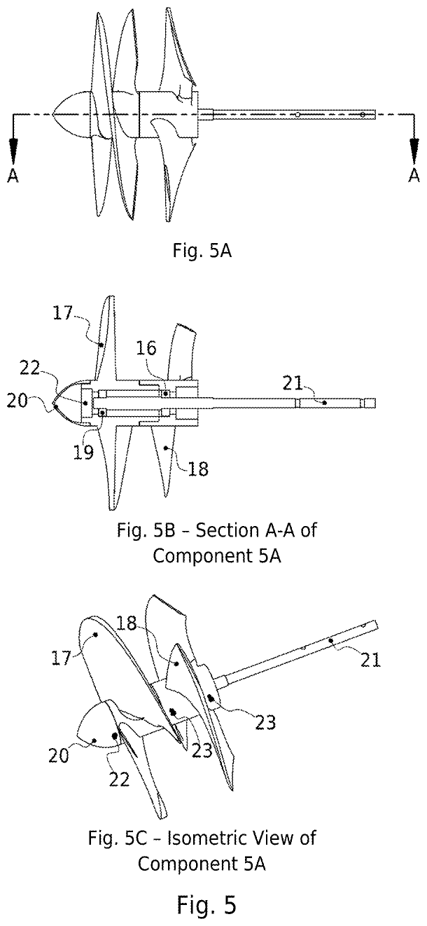

A second turbine architecture, the ENH-UPT (FIG. 5), was developed using the validated predictive CFD tool. The prototype has a diameter of 33 cm. The ENH-UPT architecture relies on pressure-driven flow exchange between blade rows: the first-row (17) functions primarily as an energy-absorbing turbine, while the second row (18) accelerates and ejects the flow, producing an amplified cyclic pressure drop that increases net energy absorption. For the ENH-UPT rotor in FIG. 5, each element's specification is listed according to Table 1.

The tested 33-cm prototype (FIG. 5) was fabricated with coated blade surfaces designed to reduce wall roughness to below 0.05 mm. The support structure includes a metallic base plate, composite supports, UPVC T-shaped piping, and internal steel reinforcement to suppress vibration up to 10,000 RPM.

FIG. 5: Drawing for ENH-UPT prototype illustrating rotor assembly. The ENH-UPT prototype has 33 cm diameter.

TABLE 1
Specifications for the ENH-UPT rotor elements.

| ELEMENT | NAME | MATERIAL | QTY. |
|---|---|---|---|
| 16 | Rear bearing 6203- | STEEL | 1 |
| | 2RS | | |
| 17 | First-row turbine | PLA | 1 |
| 18 | Second-row turbine | PLA | 1 |
| 19 | Front bearing-6203- | STEEL | 1 |
| | 2RS | | |
| 20 | Hub | PLA | 1 |
| 21 | Shaft | STEEL | 1 |
| 22 | Hub fastener | STEEL | 2 |
| 23 | Inter-row fastener | STEEL | 2 |

### F. Blade-Row Arrangement of ENH-UPT

The ENH-UPT turbine (FIG. 5) includes two rows (17, 18) of wide S-shaped blades, each with pitch variation from 0 degrees at the blade tips to approximately 30 degrees at the roots. The turbine can be either deployed in series configurations inside a cylindrical duct or without duct. For N turbines arranged sequentially, total power and torque increase by approximately 2N−1, as predicted by the CFD model.

Flow absorption is sensitive to blade curvature, hub diameter (20), pitch distribution, thickness profile, and surface roughness. CFD analysis shows that optimum inter-row spacing is about 3.3% of turbine diameter; larger gaps significantly diminish performance.

### G. Experimental Qualification of ENH-UPT

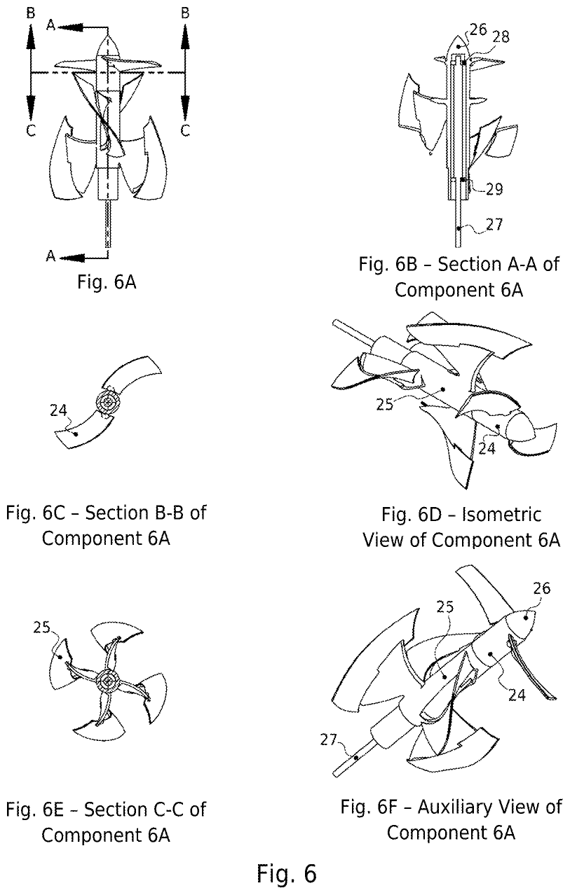

Qualitative field tests were performed without disclosing internal geometry (FIG. 5). Rotational speed was recorded using a strobe tachometer while the prototype interacted with roadside airflow, and additional tests were performed using a 50×50 cm industrial axial fan. Average wind velocity was inferred using the Zero-Turbine (FIG. 6), which operates at a constant tip-speed ratio of 1.0.

The blades (24, 25) and hub (26) of the Zero-Turbine, was made by PLA material. The Zero-Turbine includes two frictionless bearings (28, 29) installed over a shaft (27) in the rotor assembly (FIG. 6). The first-row blade (24) and the streaming-blades (25) have flow interaction and designed for preserving constant tip-speed ratio of 1.0 at low speed and moderate speed uniform flows.

FIG. 6: The Zero-Turbine prototype tested under negligible shaft torque in external wind flow.

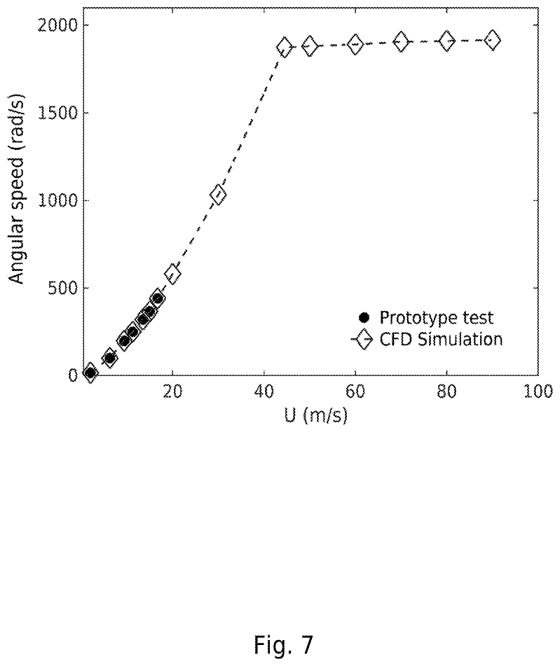

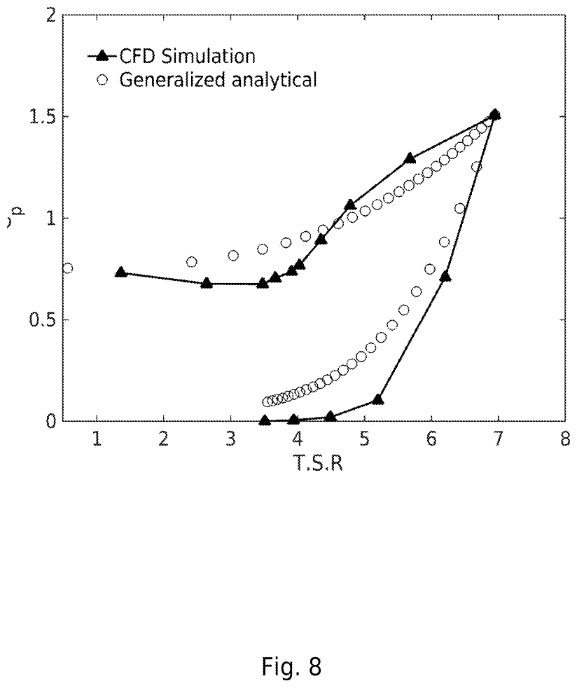

Results of field tests for ENH-UPT rotor prototype (FIG. 5) were plotted in FIG. 7. ENH-UPT reaches a stable rotational equilibrium dependent on flow speed. A generalized analytical formulation describes the condition of dynamic balance between prototype rotor (FIG. 5) and 6203-2RS bearings (16, 19). The analytical formulation by predicting balanced shaft torque, helps extending the path of experimental data for higher flow speeds, using predictive CFD simulations (FIG. 7). Power coefficient against tip-speed ratio (FIG. 8) for ENH-UPT rotor prototype (FIG. 5) in uniform wind flows were predicted by the generalized analytical formulation. The predictive CFD simulation data which describe the condition of dynamic balance between prototype rotor (FIG. 5) and 6203-2RS bearings (16, 19) are employed in the analytical formulation. FIG. 8 shows both predictive CFD simulation data and analytic data for ENH-UPT rotor prototype in uniform wind flows. The power coefficient decays after reaching to a constant rotational speed against increased flow speeds. The breaking-points in FIGS. 7, 8 correspond to an abrupt reduction of positive torque generated by ENH-UPT rotor.

FIG. 7: Rotational speed against flow speed for ENH-UPT rotor prototype in uniform wind flows.

FIG. 8: Power coefficient against tip-speed ratio for ENH-UPT rotor prototype in uniform wind flows.

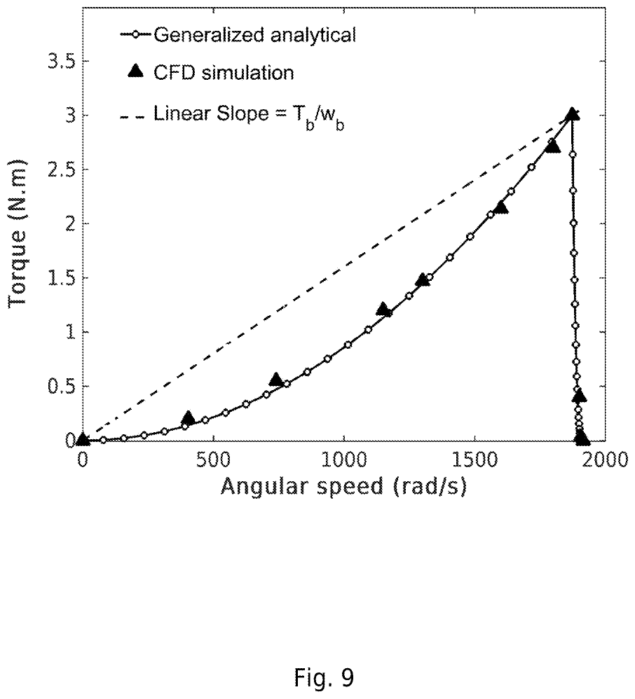

The curves for torque of ENH-UPT rotor prototype at zero-flow conditions were plotted in FIG. 9. The predictive CFD simulation data (FIG. 9) for ENH-UPT rotor at zero-flow conditions represent available torque of ENH-UPT rotor. The analytical evaluation of the available torque for ENH-UPT rotor at zero-flow conditions is illustrated in FIG. 9. When the available torque for ENH-UPT-rotor exceeds from bearings load, the rotor speeds-up to the balance angular speed, ω_{b}, at zero-flow conditions. After surpassing ω_{b}, the angular speed of the ENH-UPT rotor doesn't increase more due torque decay after breaking-point in FIG. 9.

The linear torque-path trajectory in FIG. 9 determines an upper limit for available torque of ENH-UPT rotor. When scale is changed, the linear torque-path trajectory determines optimum resistive torque of rotor during power extraction with a generator. The peak of torque curves, the point (ω_{b}, T_{b}) in the FIG. 9, illustrates the optimum power extraction rate for the ENH-UPT rotor.

FIG. 9: Predictive CFD simulation and analytical study of ENH-UPT performance under zero-flow conditions, showing optimum torque-path trajectory.

The ENH-UPT turbine operates quietly even at tip-speeds exceeding 80 m/s. Structural optimization performed using SolidWorks Simulation demonstrated that PLA components can withstand rotational speeds up to 10,000 RPM when printed with appropriate internal reinforcement.

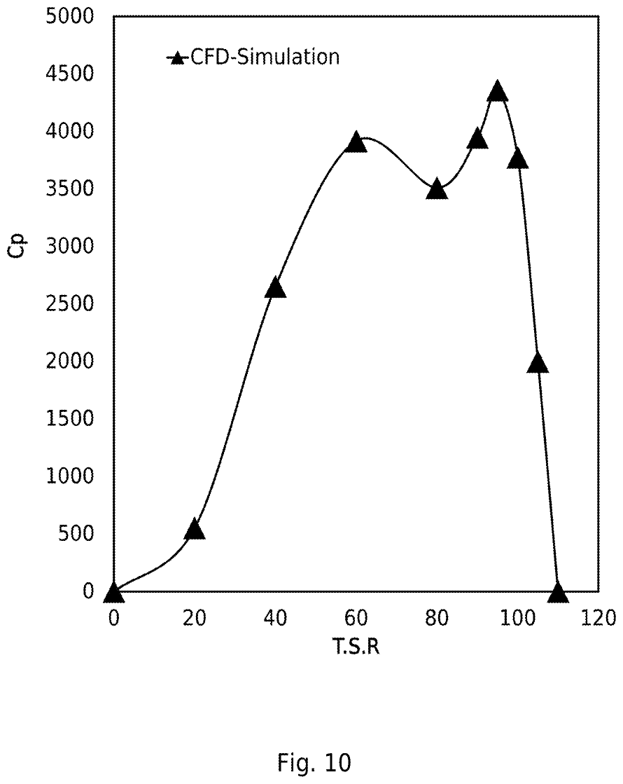

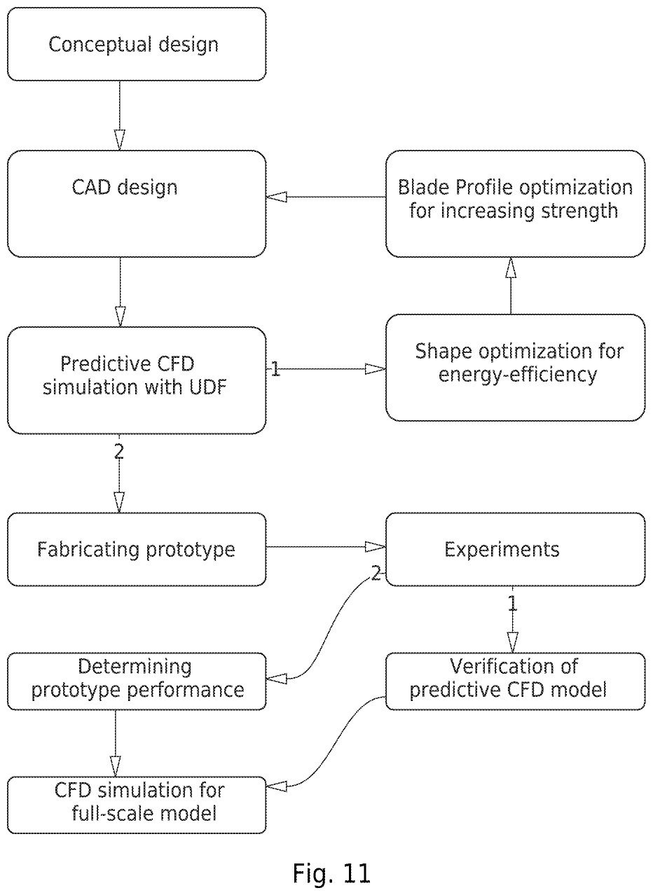

CFD simulations show substantial growth in energy extraction and power coefficient with increasing fluid density and turbine diameter. ENH-UPT with diameter 2.0 m installed in a 0.25 m/s uniform water current can extract on the order up to 106 kW with maximum power coefficient 4362 (FIG. 10). The predictive CFD data obtained relying on a verification algorithm (FIG. 11).

FIG. 10: Predictive CFD simulation for ENH-UPT in water including cavitation.

### H. Pressure-Driven Ambient Energy Extraction

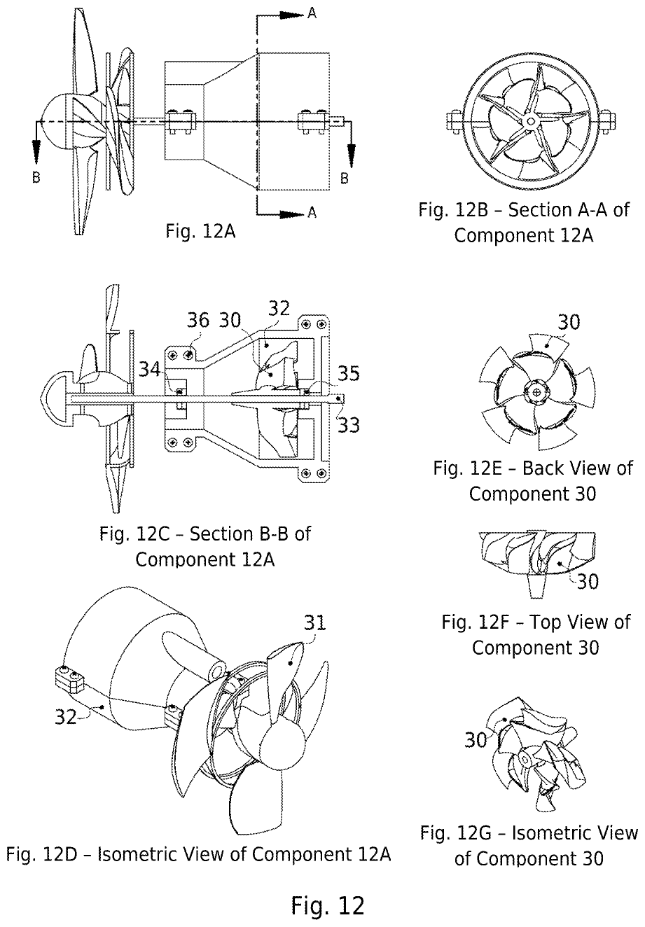

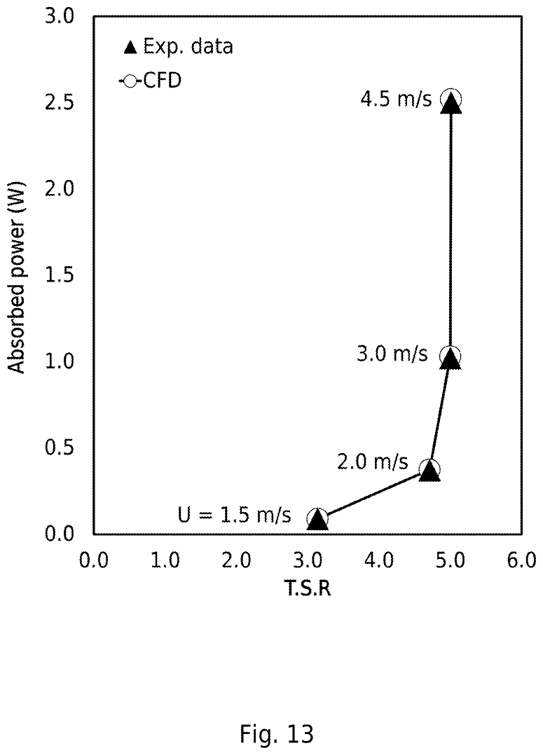

The inventions in FIG. 5 and FIG. 12 enable direct extraction of renewable energy from ambient pressure fields. Sample measured data related to pressure-driven ambient energy extraction are shown in FIG. 3 and FIG. 13 that exhibit power coefficient greater than 1.0. Thermal energy of compressible fluids and hydrostatic pressure differences act as reservoirs of potential energy that are transferred into mechanical form during turbine operation. The ENH-UPT architecture extracts this energy through repetitive pressure-driven flow exchange, with far-field potential energy replenishing localized pressure deficits generated by the turbine.

### I. Control Algorithms for Ultra-Efficient Cooling Systems

The predictive CFD model also enables the design of automated or mechanically regulated speed-control systems for thermal-management applications. An example involving a “zero-power” air-cooler producing approximately 3.3 kW of cooling capacity through serially coupled ENH-UPT turbines mounted on a rotor. Rotor speed is maintained at 25,000 RPM with negligible net torque. Stators help stabilize rotation, while the rotor receives a precisely metered jet of air from a silent micro-nozzle compressor to prevent overspeed or deceleration. The rotor diameter in this system is 16.5 cm, and airflow of 1.45 kg/s produces an outlet temperature drop of approximately 4° C.

Circulation of humid ambient air through a closed chamber equipped with inlet and outlet vents allows significant condensation. Analytical estimates indicate that such a system can yield up to 3.0 m³/day of clean distilled water at relative humidity above 50%.

M. Prototyping of a Renewable Turbo-Cooler with Experimentation for CFD Model Verification

A light-weight 3D-printed turbo-rotor including four rows of series ENH-UPT turbines (8.0 cm in diameter) was tested with air suction-flow of a 24.0 Watts Delta (FFB1224EHE) axial fan in a small convergent-divergent duct without installing stators. A 12.0 Volte digital thermometer including a small thermal measuring probe with high accuracy (0.1 C) could measure-0.3 degrees of Celsius temperature drop at the distance 1.0 cm from suction side of the axial fan. The measured temperature-drop at the distance 1.0 cm downstream of turbo-rotor in the duct throat was-0.5 degrees of Celsius relative to the room temperature. Measurements were repeated for controlled thermal condition in the isolated room. During experimentation the turbo-rotor speed was measured around 15000 RPM and while turbo-rotor friction with air flow dominantly prevents overspeed. The predictive CFD simulation could illustrate both fluid dynamics of the air flow over turbo-rotor and the temperature distribution in the air flow accurately. Predictive CFD method and experimentation exhibit closely 40 W-35 W cooling rate for the small prototype of renewable turbo-cooler. The input electrical powers for running the 4000 RPM Delta axial fan (FFB1224EHE) and for the digital thermo-meter were controlled in a parallel manner with a laboratory power supply. In the experimentation the duct throat axial flow velocity generated by suction of fan was around 12 m/s. The turbo-rotor average wall roughness (0.05 mm), and the room temperature (27.3 C) with elevation from see level (1480 m) were considered in the predictive CFD simulation for obtaining accurate results.

### EMBODIMENTS

This section describes representative embodiments of the Pressure-Driven Energy Source, the Ultra-Power Turbine (UPT), the Enhanced-Ultra-Power Turbine (ENH-UPT), and integrated systems utilizing the predictive CFD tool. These embodiments are examples only and are not intended to limit the scope of the invention.

### A. Ultra-Power Turbine (UPT) Embodiments

At velocity augmented external flow around transportation systems, the UPT configuration shown in FIG. 2 exhibits a drag-force coefficient lower than its power coefficient, demonstrating unusually high aerodynamic efficiency. The UPT may supply mechanical or electrical power for transportation systems when coupled to a power-transmission mechanism. The turbine's elevated power coefficient allows sustained energy extraction even in moderate flow conditions.

### B. Control Algorithms for Ultra-Efficient Cooling Systems Using ENH-UPT Turbines

Depending on performance requirements, multiple control architectures may be implemented, including mechanical, electrical, or hybrid electro-mechanical speed-control systems.

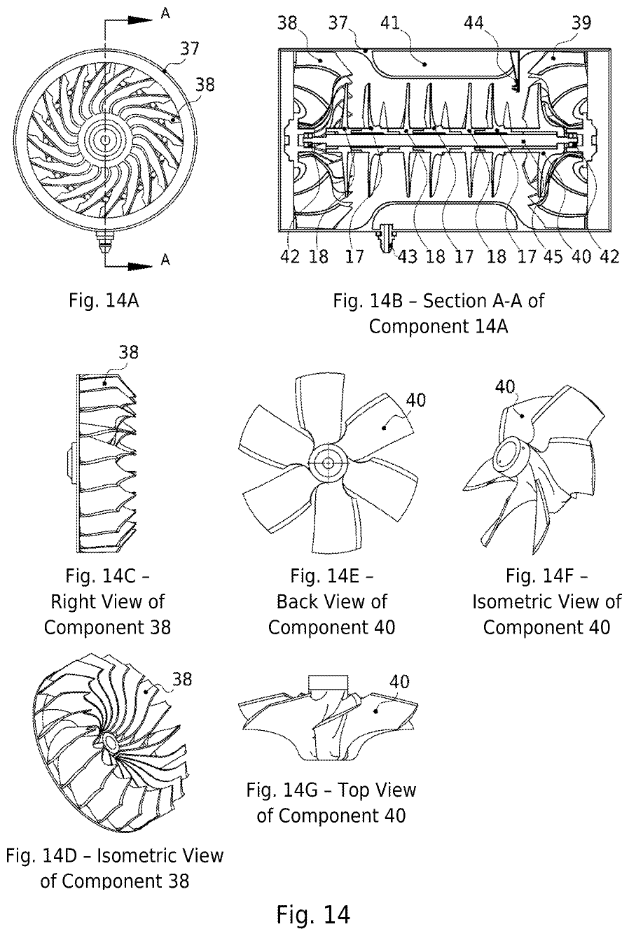

An applied embodiment is illustrated in FIG. 14. Using the corrected predictive CFD model, a zero-power air-cooling unit with a 3.3 kW cooling capacity was designed. The system employs a series-coupled set of ENH-UPT turbines (17,18) mounted on a common rotor. Frictionless bearings (42) installed on the ends of rotor shaft (45). The turbines mutually balance torque through interaction with appropriately designed stators (38,39), stabilizing rotor speed at 25,000 RPM. Compressed air enters from pneumatic connection (43) to a vessel (41) through duct (37) for speed-up purpose.

FIG. 14: The zero-power air-cooling unit. The system employs a series-coupled set of ENH-UPT turbines.

CFD simulations indicate that at 25,000 RPM the net rotor torque approaches zero, enabling operation at near-equilibrium with minimal external input. A secondary speed-control mechanism maintains stability: a silent compressor delivers a controlled micro-nozzle (44) air jet to the rotor involving a speed-controller propeller (40), compensating for fluctuations that would otherwise cause deceleration or unstable rotation.

The rotor diameter is 16.5 cm. Air flows through the turbine assembly at mass-flow rate 1.45 kg/s, producing an outlet temperature reduction of approximately 4° C. In a closed-loop configuration with inlet/outlet vents for humid air, the system enables water condensation and distillation. Analytical estimations indicate that, under humid conditions exceeding 50% relative humidity, the zero-power air-cooler embodiment can yield up to 3.0 m³/day of condensed clean water.

### C. Thrust Generation for Transportation Vehicles

An ENH-UPT turbine with a 33 cm prototype rotor can be integrated with a mechanical power-transmission system to generate thrust for automotive applications. When oriented opposite the vehicle's forward direction of motion, the turbine rotates as if operating in a direct-faced flow configuration. The thrust coefficient of the ENH-UPT turbine is comparable to its power coefficient, allowing it to offset aerodynamic drag and rolling resistance forces, thereby reducing fuel or energy consumption. A torque converter positioned between the ENH-UPT turbine and the drivetrain protects the mechanism from excessive angular acceleration during rapid braking events.

### D. Alternative Embodiments

The invention and predictive CFD tool can be applied to a broad set of systems and industries. The following represent possible alternative embodiments:

### Water Condensation and Air-Cooling Systems

Renewable cooling, dehumidification, and water-condensation systems in environments with high humidity.

### Transportation (Water)

Marine propulsion assistance, drag-reduction systems, and onboard auxiliary power generation.

### Transportation (Air)

Airborne vehicle thrust augmentation, onboard renewable generators, and low-density airflow turbines.

### Transportation (Space)

Low-density gas energy extraction, micro-thrusters, and regenerative turbine-driven flow control in spacecraft life-support systems.

### Power Generation (Water)

Hydrodynamic turbines for rivers, tidal streams, and low-head hydro sources where predictive CFD enables performance optimization.

### Power Generation (Air)

High-efficiency aerodynamic turbines for compact wind-energy harvesting, urban wind channels, and vehicle-mounted systems.

### Power Generation (Low-Density Gases)

Turbines designed for operation in low-density atmospheric environments, including high-altitude platforms and extraterrestrial environments.

### Heating, Cooling, and Air-Conditioning Systems

Integration of ENH-UPT or UPT turbines for circulation, compression assistance, or hybrid thermodynamic cycles.

Accurate CFD Modeling of Rotating Turbines (Horizontal and Vertical Axis) Predictive simulation of multi-axis turbines for renewable energy, propulsion, or ventilation systems.

### CFD Modeling for Turbomachinery (Turbines)

Enhanced accuracy in simulating internal flow turbines, impulse turbines, and reaction-type rotating machinery.

### CFD Modeling for Fans, Blowers, and Compressors

High-resolution predictions of pressure rise, torque behavior, flow stability, and stall margins.

### General Turbomachinery Modeling

Universal CFD architecture for rotating equipment including pumps, expanders, ventilators, and hybrid rotor-stator systems.

### Derivation of Corrections for the Momentum Equation for CFD Modeling of Rotating Turbines

This section provides the derivation of momentum-correction source terms required to obtain exact fluid-dynamic solutions within a rotating fluid domain. The corrections are formulated in a general Cartesian coordinate system and are compatible with conventional absolute-velocity formulations used in commercial CFD solvers such as ANSYS FLUENT.

### A. General Framework and Governing Principles

The derivation begins from the energy-conservation principle applied to fluid motion interacting with the moving boundaries of turbine blades. The turbine walls impose work on the surrounding fluid, and fluid particles are subjected to pressure gradients generated by the rotating geometry. These interactions introduce additional momentum transfer mechanisms that are not fully accounted for in the standard RRF momentum equations and mesh motion momentum equations of common CFD software packages.

To correct this discrepancy, momentum-source terms are derived that represent the distributed energy and momentum exchange occurring inside stream tubes that pass through the rotating fluid domain. Each stream tube originates at the far-field flow and continues inward through the rotating domain. Verification of the User-Defined Function (UDF) implementation was performed using a small-scale three-blade wind-turbine geometry provided in reference [1].

### B. Momentum Source Term Formulation

The momentum-source term vector for each stream tube within the rotating fluid domain is defined by the energy work rate applied by the fluid to the rotating boundaries, expressed in absolute-velocity formulation. This ensures compatibility with transient rotating fluid domain simulations. The momentum source term vector for element i within a stream tube is expressed as:

$${s}_{i} = {( {S}_{i} )}_{{Stream - tube}_{i - element} ,} / d {∀}_{i - element} \qquad ( 1 - a )$$

$${( {S}_{i} )}_{{Stream - tube}_{i - element} ,} ≡ \frac{{( \begin{matrix}{\dot{E}}_{{absorb ,}_{turbine}}\end{matrix} )}_{{Stream - tube ,}_{i - element}}}{{R}_{0}} \qquad ( 1 - b )$$

$${s}_{i} = \frac{{F}_{i - element on wall} \cdot {U}_{w a l l}}{{R}_{0} \vert {dA}_{i - element} \vert \vert {dX}_{i - element} \vert} \qquad ( 1 - c )$$

In the Cartesian coordinate system of the rotating fluid domain, with the y-axis defined as the turbine's rotational axis, the volumetric components of the momentum-correction terms are expressed as:

$${( {s}_{{i}_{x}} )}_{R R F} = {\int }_{{X}_{i}}^{wall} \frac{{∇}_{xP {dynamic ,}_{ignored}}}{{R}_{0}} dX ≡ \frac{0.5 ρ {U}_{rel - x}^{2}}{{R}_{0}} \frac{x \cdot ω}{\vert x \vert \vert ω \vert} n \qquad ( 2 - a )$$

$${( {s}_{{i}_{y}} )}_{R R F} = {\int }_{{X}_{i}}^{wall} \frac{{∇}_{yP {dynamic ,}_{ignored}}}{{R}_{0}} dX ≡ - \frac{0.5 ρ {U}_{rel - y}^{2}}{{R}_{0}} n ( y : rotation - axis ) \qquad ( 2 - b )$$

$${( {s}_{{i}_{z}} )}_{R R F} = {\int }_{{X}_{i}}^{wall} \frac{{∇}_{zP {dynamic ,}_{ignored}}}{{R}_{0}} dX ≡ \frac{0.5 ρ {U}_{rel - z}^{2}}{{R}_{0}} \frac{z \cdot ω}{\vert z \vert \vert ω \vert} n \qquad ( 2 - c )$$

These components correspond to the distributed body-force fields required to reproduce the exact dynamic effect of rotation-induced work and pressure redistribution.

### C. Correction of Ignored Dynamic Pressures

Standard RRF and mesh motion formulations often omit certain dynamic-pressure contributions arising from the relative motion between rotating surfaces and transported fluid mass. To obtain an exact solution, these ignored dynamic-pressure terms are incorporated into the corrected momentum equation as:

$$0.5 ρ {U}_{r e l - x}^{2} = 0.5 ρ {u}_{θ}^{2} - 0.5 ρ {U}_{x}^{2} \qquad ( 3 - a )$$

$$0.5 ρ {U}_{r e l - y}^{2} = 0.5 ρ {u}_{θ}^{2} - 0.5 ρ {U}_{y}^{2} \qquad ( 3 - b )$$

$$0.5 ρ {U}_{r e l - z}^{2} = 0.5 ρ {u}_{θ}^{2} - 0.5 ρ {U}_{z}^{2} \qquad ( 3 - c )$$

$${u}_{θ} = \vert r \times ω \vert \qquad ( 3 - d )$$

These terms ensure that the corrected momentum balance reflects the true instantaneous mechanical interaction between fluid and blades across the entire rotating fluid domain.

### D. Power-Absorption Index

The power absorption index provides a quantitative measure of local and global energy extraction in the rotating fluid domain. It is defined as:

$$n = + 1 when power absorbed from fluid by rotating walls \qquad ( 4 - a )$$

$$n = - 1 when power applied to fluid by rotating walls \qquad ( 4 - b )$$

A second, more representative form of the power absorption index—used throughout later validation sections—is expressed as:

$$n = SIGN [ ( {p}_{abs} - {p}_{reference} ) {U}_{y} ] \qquad ( 5 )$$

These indices serve as key parameters for diagnosing turbine efficiency, verifying CFD-model convergence, and ensuring consistency with experimental measurements.

### E. Generality and Applicability

The derivation is performed using absolute velocity formulation, ensuring compatibility with the general form of the governing equations for fluid flow. As a result, the correction methodology is broadly applicable to: RANS equations; Compressible and incompressible flows; Non-Newtonian fluids; Multiphase systems.

All major turbulence models—including k−ε, k−ω, Reynolds Stress Model (RSM), and SST-Transitional approaches—remain fully compatible with the correction source terms. Numerical convergence is preserved because the correction modifies only the momentum equation while leaving the energy equation unchanged.

Only transient rotating fluid domain simulations is supported. When the corrected momentum equation is solved alongside the unchanged energy equation, the resulting CFD predictions match exact mechanical-energy transfer behavior. Validation results provided in subsequent sections demonstrate the accuracy of this corrected CFD model when compared with experimental and analytical benchmarks.

### CFD Verification

This section presents verification of the corrected momentum-equation model and the associated User-Defined Function (UDF) implemented in ANSYS-FLUENT 2019-2024. Validation is performed using published experimental data, prototype turbine measurements, and benchmark symmetric-flow cases.

### A. Validated C-Program (UDF) for ANSYS-FLUENT 2019-2024

A dedicated UDF was developed in the C programming language to correct the momentum equations in the rotating fluid domain. The UDF operates as an interpreted function in ANSYS-FLUENT 2019-2024 and can also be compiled in ANSYS-FLUENT 2024 for improved computational efficiency. A transient parallel coupled solver is recommended for rapid convergence.

The UDF possesses the following characteristics:
a. Independence of source-term functions from incoming flow direction.
b. Correct handling of turbine rotation reversal through true sign-changing source terms.
c. Vanishing drag contribution for symmetric benchmark cases, including cross-plate rotation in a quiescent fluid.
d. Full generality of momentum source-term expressions.
e. Consistency with fluid dynamics and thermodynamic energy-work relationships.
f. Internal consistency across all Cartesian components of the momentum source terms.
g. Exact prediction of runaway speed for rotating turbines.
h. Accurate prediction of wake-velocity deficit downstream of rotating machines.
i. Full compatibility with commercial rotating fluid implementations (e.g., ANSYS-FLUENT mesh motion formulation).
j. Compatibility with all turbulence models, including k−ε, k−ω, SST, RSM, and transitional models.
k. Applicability to all fluid types and operating conditions, including compressible and multiphase flows.
l. Direct applicability to fans, blowers, and related turbomachinery, providing more accurate results than uncorrected rotating fluid simulations.

### B. Validation of Corrected CFD Model Using Published Wind-Turbine Data

The CFD model—ANSYS-FLUENT 2019/2024 with the correction UDF—was validated using authoritative literature data for wind-turbine performance.

A comparison between predictive CFD and reported measurements for the power-coefficient curve of a reference wind turbine at a range of Reynolds numbers 1.0×10⁵ to 3.0×10⁵ showed agreement between data with overall error less than 2%. The turbine blade geometry was obtained from reference [1]. The CFD model accurately reproduces three critical regions of the power-coefficient curve: below-stall conditions, the peak-efficiency region, and the post-stall decline.

### C. Experimental Validation Using the Zero-Turbine Prototype

Further validation was performed using a three-row axial wind turbine referred to as the Zero-Turbine, shown in FIG. 6.

The Zero-Turbine was designed to operate at a tip-speed ratio (TSR) of 1.0 with negligible shaft torque. The blade assembly was fabricated using PLA material with 100-micron resolution via 3D printing and has a rotor diameter of 11.0 cm.

Experimental tests were conducted under ambient airflows ranging from 5 to 20 m/s, with air density 0.99 kg/m³. CFD simulations were conducted under identical conditions. The corrected CFD model predicted the runaway speed precisely: at TSR=1.0 the turbine exhibits zero shaft torque, in full agreement with experimental observations. This validates the accuracy of the momentum-correction UDF and the fidelity of the predictive CFD tool.

Because of its stable TSR=1.0 behavior, the Zero-Turbine is suitable for use as a compact airflow-velocity measurement device when paired with a stroboscopic tachometer.

### D. Experimental Validation Using the Ultra-Power Turbine (UPT) Prototype

Experimental tests were conducted for Ultra-Power Turbine (UPT) turbine under ambient airflows ranging from 1.5-4.5 m/s. The air density was 0.99 kg/m³, uniform for all tests. Table 2, illustrates validity of the UDF with less than 1.1% error during predicting power coefficient of the Ultra-Power Turbine (UPT) related to experimental measurements:

TABLE 2
UDF validation with CFD simulation of Ultra-Power Turbine
(UPT) prototype.

| Corrected | | | | |
|---|---|---|---|---|
| CFD simulation | 1 | 2 | 3 | 4 |
| Area-averaged axial component velocity | 1.5 | 2.0 | 3.0 | 4.5 |
| of air (m/sec) | | | | |
| Tip-speed ratio of turbine | 3.14 | 4.71 | 5.00 | 5.01 |
| Power coefficient of UPT, CFD | 3.13 | 5.60 | 4.49 | 3.27 |
| simulation with predictive UDF | | | | |
| Power coefficient of UPT, Experiments | 3.10 | 5.54 | 4.44 | 3.24 |
| Difference between CFD and | −1 | −1 | −1.1 | −1 |
| Experiments (%) | | | | |

### E. Verification Flow-Chart

A process flow-chart describing the design, simulation, and prototyping workflow is shown in FIG. 11. The predictive CFD tool has undergone extensive multi-stage validation through both simulation and physical prototyping using a variety of axial turbine configurations.

FIG. 11: Flow-chart indicating major steps in verification of the momentum-correction UDF and predictive CFD model. Multiple axial-turbine prototypes were fabricated and tested to establish generality of the method.

### F. CFD Architecture and Simulation Pipeline

The CFD architecture is based on ANSYS-FLUENT 2019/2024. The standard pipeline is as follows:
a. Create turbine geometry in SolidWorks using parametric dimensions and flexible blade shapes.
b. Partition the simulation domain into stationary and rotating fluid domains.
c. Import geometry into ANSYS DesignModeler 2024.
d. Generate high-quality meshes using ANSYS Meshing 2024, applying interface boundaries around the rotating fluid domain.
e. Import the mesh into the parallel solver of ANSYS-FLUENT 2024.
f. Compile the UDF to correct the momentum equations.
g. Select the transient coupled solver for rapid convergence.
h. Activate force and moment monitors and run transient mesh motion simulations using absolute-velocity formulation.

This simulation pipeline consistently produces stable, convergent, and accurate CFD solutions for rotating machinery.

### G. Benchmark Solution for UDF Verification

A benchmark test involving a cross-plate rotating in stationary water was conducted to verify that the UDF does not introduce non-physical axial forces in symmetric flow conditions. The cross-plates have a width and length of 1.0 m and rotate at 40 rad/s in quiescent water. In contrast, the corrected predictive CFD model maintains exactly zero drag, confirming the physical correctness and symmetry of the formulation.

### Experiments

### A. Experiments for the Ultra-Power Turbine (UPT)

The next stage of validation for the corrective UDF and predictive CFD model corresponds to the Ultra-Power Turbine (UPT). FIG. 3 demonstrates the capability of the CFD tool to support advanced turbine designs exhibiting significantly higher power coefficients. To highlight the importance of predictive CFD modeling, a complete prototyping and experimental evaluation of a small-scale Ultra-Power Wind Turbine (UPT) was performed. The investigated UPT consists of a two-bladed first row and a mixed four-bladed second row. The UPT is a horizontal-axis wind turbine designed for controlled total-pressure changes across blade passages such that local flow acceleration and pressure gradients lead to substantially increased absorbed power from the surrounding flow.

The final UPT prototype (FIG. 2) exhibits markedly higher angular velocity and a large enhancement in power absorption relative to earlier non-optimized configurations (FIG. 1), which had power coefficients below 1.0. With the aid of the predictive CFD tool and the corrected momentum equations, the optimized UPT reached an optimum power coefficient of 5.54.

### B. Experimental Methodology

A combined aerodynamic-electromechanical testing method was developed to measure the power coefficient of the UPT. A five-blade propeller with known performance characteristics was coupled to the UPT to serve as a calibrated aerodynamic and mechanical load. A low-friction spindle with precisely fabricated clearances was manufactured. A cubic algebraic model was developed to predict both the frictional power of the spindle and the aerodynamic power of the propeller.

A laboratory power supply and a high-speed electro-motor were used to characterize the aerodynamic resistance of the propeller in quiescent air. This allowed accurate derivation of absorbed mechanical power when the propeller was driven by the UPT under free-stream wind. Using this methodology, the maximum recorded power coefficient of the UPT reached 5.54.

The designation “Ultra-Power Turbine” originates from the turbine's ability to achieve power coefficients far exceeding unity.

### C. Fabrication of the Five-Blade Propeller

The propeller (30) was fabricated using a professional FDM 3D printer with PLA material at 100-micron accuracy. As illustrated in FIG. 12, the propeller hub and blades were designed to generate high aerodynamic resistance when rotating. The propeller diameter was 7.0 cm. During testing, the propeller could be mounted inside the spindle cavity (32) to eliminate incoming wind effects (FIG. 12).

FIG. 12: Depicts the internal structure of a low-friction spindle. The spindle housing (32) is constructed from PLA, the shaft (33) from stainless steel, and the five-blade 7.0 cm-diameter propeller (30) is fabricated using FDM technology and mounted inside the spindle.

Laboratory DC power-supply was used to deliver constant electrical power to a high-speed (5560 RPM) miniature electro-motor for measuring ultimate angular velocity of rotating components under a constant 2.5-Watt input.

### D. Fabrication of the Spindle Assembly

The spindle (32) was fabricated using PLA at 200-micron accuracy. The internal spindle structure is shown in FIG. 12. Stainless-steel shafts (33) and lubricated miniature bearings (34, 35) were integrated to minimize friction. Following lubrication with machine oil, the spindle demonstrated extremely low friction, enabling high-precision torque and power measurements. The propeller (30) could be housed inside the spindle (32) as shown in FIG. 12 or mounted externally.

### E. Measurement Instruments and Test Conditions

A strobe-light tachometer (accuracy: 5 RPM) was used for angular velocity measurements. A calibrated hot-wire anemometer (accuracy: 0.1-0.3 m/s) measured time-averaged air velocity. Ambient conditions were stable during all tests: elevation of 1486 m, air density of 0.99 kg/m³, and relative humidity of 15%. A colored marking on each rotating part ensured accurate strobe-tachometer readings.

A laboratory power supply provided constant electrical power to the electro-motor (5.0 V, 2.5 W). Under this controlled input, the electro-motor reached 5560 RPM in still air. When driving only the spindle (without the turbine (31)), the rotor reached 2875 RPM at the same 2.5 W power input.

### F. Wind-Generation System

A 33-W axial-fan motor running at 2500 RPM drove a 28-cm poly-wood propeller, was used to generate a wide, nearly axisymmetric wind field with uniform axial components. Swirl intensity remained below 10% of mean axial velocity. For accurate determination of turbine power coefficient, the total kinetic power of the flow, including both axial and residual swirl components, was used.

The Ultra-Power Turbine prototype (31) was mounted on the spindle and tested across axial wind velocities from 1.5 to 4.5 m/s.

### G. Cubic Algebraic Equation for Estimating Turbine Power Absorption as a Function of Turbine Angular Velocity for Various Wind Flow Velocities

For the experimental configuration shown in FIG. 12, the aerodynamic-resistive power of propeller plus frictional power of spindle shaft is equal to the turbine power absorption rate. A cubic algebraic equation which is calibrated by two boundary conditions can predict turbine power (for configuration in FIG. 12) for a wide range of wind flow velocities (low-speed and moderate speed flows). Boundary conditions are related to data sampling for aerodynamic-resistive power of propeller (30) plus frictional power of spindle shaft (33).

According to Eq. (6) a cubic algebraic equation was employed for estimating power absorption of turbine or total resistive powers:

$${\dot{E}}_{{absorb ,}_{turbine}} = {\dot{E}}_{resistive} = {\dot{E}}_{propeller} + {\dot{E}}_{friction} = a {ω}^{3} + b {ω}^{2} + c ω + d \qquad ( 6 )$$

In Eq. (6), ω is angular velocity of spindle shaft (33) in rad/sec and Ėᵣₑₛᵢₛₜᵢᵥₑ is total resistive power including aerodynamic resistive power of propeller (30) and frictional resistive power of spindle shaft. Boundary conditions for Eq. (6) are zero turbine power and its derivative at ω=0:

$${{{\dot{E}}_{{absorb ,}_{turbine}} \vert}_{ω = 0} = 0 , \frac{d ( {\dot{E}}_{{absorb ,}_{turbine}} )}{d ω} \vert}_{ω = 0} = 0 \qquad ( 7 )$$

Zero turbine power at ω=0 mean the turbine doesn't generate power at ω=0. Zero derivative of turbine power at ω=0 mean the turbine power doesn't change with ω around ω=0 which is acceptable for a horizontal axis wind turbine with zero slope in power coefficient curve against tip-speed ratio at ω=0. Using the two boundary conditions in Eq. (7), empirical constants c and d in Eq. (6) are found to be zero and Eq. (6) is reduced to Eq. (8):

$${\dot{E}}_{resistive} = {\dot{E}}_{propeller} + {\dot{E}}_{friction} = a {ω}^{3} + b {ω}^{2} \qquad ( 8 )$$

For determining empirical constants a and b, two other experiments were done. In the first experiment the electrical input power (Ėᵣₑₛᵢₛₜᵢᵥₑ) was 2.5 Watts and the steady angular velocity of spindle shaft (connected only to propeller (30)) was ω=300.9 rad/sec. In the second experiment the propeller (30) was coupled directly to the electro-motor and the constant a was determined by Eq. (9) that presents aerodynamic resistive power of propeller:

$${\dot{E}}_{propeller} = a {ω}^{3} \qquad ( 9 )$$

In the second experiment Ėₚᵣₒₚₑₗₗₑᵣ was equal to the electro-motor input power (i.e 2.5 Watts) while the propeller angular velocity was ω=482.7 rad/sec. With Eq's. (8, 9) and with sample data (relevant to the first and second experiments) the unknown empirical constants were determined: a=2.22×10⁻⁸ and b=2.11×10⁻⁵. For experimental configuration in FIG. 12 the cubic algebraic Eq. (8) is rewritten as Eq. (10) for predicting turbine power absorption in Watts based on angular velocity in rad/sec for various wind flow velocities (low-speed and moderate speed flows):

$${\dot{E}}_{{absorb ,}_{turbine}} = {\dot{E}}_{p r o p e l l e r} + {\dot{E}}_{f riction} = 2.22 \times 1 {0}^{- 8} {ω}^{3} + 2.11 \times 1 {0}^{- 5} {ω}^{2} \qquad ( 10 )$$

Dividing Eq. (10) by angular velocity of turbine (ω) yields an empirical relation for turbine torque in N·m for various wind flow velocities (low-speed and moderate speed flows):

$${T}_{{absorb ,}_{turbine}} = {T}_{p r o p e l l e r} + {T}_{f riction} = 2.22 \times 1 {0}^{- 8} {ω}^{2} + 2.11 \times 1 {0}^{- 5} ω \qquad ( 11 )$$

### H. Experimental Results

The measured data were summarized in Table 3. Four independent experimental runs were performed, and averaged data were reported. Adjustments were made to avoid over-estimation of turbine power coefficient by accounting for kinetic energy contributions from residual swirling components. According to Table 3:
a. Maximum power coefficient: 5.54, obtained at tip-speed ratio 4.71.
b. Air density: 0.99 kg/m³, uniform for all tests.
c. Wind velocity range: 1.5-4.5 m/s.

TABLE 3
Results for measuring power coefficient of turbine at different tip-
speed ratios related to experimental configuration in FIG. 12.

| Experiment number | 1 | 2 | 3 | 4 |
|---|---|---|---|---|
| Area-averaged axial | 1.5 | 2.0 | 3.0 | 4.5 |
| component velocity of air | | | | |
| (m/sec) | | | | |
| Maximum swirling velocity | Negli- | Negli- | 0.3 | 0.5 |
| (m/sec) | gible | gible | | |
| Angular velocity of turbine | 62.8 | 125.6 | 200 | 300.9 |
| (rad/sec) | | | | |
| Turbine power absorption | 0.0887 | 0.370 | 1.021 | 2.50 |
| (Watt) | | | | |
| Total flow kinetic power | 0.0286 | 0.068 | 0.229 | 0.770 |
| toward turbine (Watt) | | | | |
| Tip-speed ratio of turbine | 3.14 | 4.71 | 5.00 | 5.01 |
| Power coefficient of turbine | 3.10 | 5.54 | 4.44 | 3.24 |

FIG. 13 plots absorbed turbine power versus tip-speed ratio for various wind speeds. At TSR=5.0, absorbed power increased from approximately 1.021 W to 2.50 W, as axial velocity increased from 3.0 to 4.5 m/s.

The power coefficient defined in Eq. (12) was plotted against tip-speed ratio in FIG. 3.

$${C}_{P} = \frac{Absorbed power by turbine}{Total flow kinetic power} = \frac{{T}_{t u r b i n e} ω}{0.5 ρ {U}^{3} {A}_{t u r b i n e}} \qquad ( 12 )$$

### 8.1.8 Torque and Friction Analysis

For the configuration in FIG. 12, absorbed power equals the sum of aerodynamic resistance power and spindle frictional power. Turbine torque, derived using algebraic Eq. (6), matches the sum of all resistive torques.

The friction torque curve follows the Stribeck profile, exhibiting linear dependence in the hydrodynamic lubrication regime. This is consistent with the high rotational speeds and minimal bearing loads observed in the present experiments.

FIG. 13: Absorbed power for the Ultra-Power Turbine at various tip-speed ratios and airflow velocities, corresponding to the setup of FIG. 12.

### I. Experiments for the Enhanced-Ultra-Power Turbine (ENH-UPT)

A second turbine prototype, designated ENH-UPT, was evaluated experimentally to further demonstrate the predictive capabilities of the corrected CFD tool. The ENH-UPT prototype (FIG. 5) has a diameter of 33 cm. Its detailed geometry, including blade arrangement and shaft assembly, is shown in FIG. 5.

### J. Turbine Characteristics

The ENH-UPT turbine uses two blade rows with four wide S-shaped blades. The first-row functions as a turbine, while the second row further accelerates local flow, enhancing pressure-driven energy transfer. Predictive CFD simulations showed that significant power augmentation results from cyclic pressure exchange between blade rows.

Increasing turbine diameter increases both energy extraction rate and power coefficient because centrifugal effects and frictional torques become less dominant at larger scales. Simulations indicate that an ENH-UPT turbine of 2.0 m diameter operating in a uniform 0.25 m/s water current can extract approximately 106 kW of power.

Prototype blades were coated with metallic paint followed by two layers of plastic spray to reduce surface friction.

### K. Blade-Row Arrangement and Design Considerations

The ENH-UPT turbine incorporates:
a. Two blade rows, each with four wide blades.
b. Pitch-angle distribution varying from 0° at blade tips to 30° near blade roots.
c. S-shaped blade profiles optimized for momentum exchange.
d. Optimal blade-row spacing equal to approximately 3.3% of turbine diameter.
e. Capability for serial installation inside a cylindrical duct, where output power scales as 2N−1 for N stages.
f. Flow absorption efficiency is highly sensitive to hub diameter, curvature, thickness distribution, pitch variation, and surface roughness.

### L. Experimental Evaluation

Qualitative experiments were conducted without disclosing sensitive design information. The ENH-UPT prototype was evaluated under wind flows generated both by vehicle motion and by a 50 cm×50 cm axial fan. Angular velocity was measured by a strobe-light tachometer. Average wind velocity was determined using the Zero-Turbine (FIG. 6), which maintains a constant TSR=1.0, making it a reliable flow-velocity measurement instrument.

Experimental data for ENH-UPT rotor prototype are summarized in FIG. 7. The ENH-UPT prototype demonstrated:
a. Silent operation at very high rotational speeds.
b. Tip-speed exceeding 80 m/s.
c. Structural integrity up to 10,000 RPM, confirmed by SolidWorks-Simulation 2021.

These experiments confirm the design principles produced by the corrected CFD model and demonstrate the feasibility of high-efficiency, pressure-driven multi-row turbines.

### Generalized Analytical Formulation

### A. Generalized Analytical Formulation for Multi-Scale ENH-UPT Operation Under Zero- and Non-Zero-Flow Conditions

A generalized analytical framework is developed to characterize the dynamic performance and energy extraction capability of ENH-UPT turbines across arbitrary physical scales and operating conditions. This formulation significantly reduces the number of CFD simulations required, while retaining high predictive accuracy for both zero-flow and non-zero-flow regimes. The methodology applies to single ENH-UPT turbines as well as series-coupled configurations comprised of (N) ENH-UPT units operating within a Newtonian fluid.

The analytical relations were derived based on geometric similarity, dynamic similarity, and the conservation of energy. A blending function with averaging constant (q), defined by Eq. (14), ensures a continuous and physically consistent transition between zero-flow and non-zero-flow operating regimes. Equations (13) through (21) provide the complete analytical formulation and have been validated against CFD datasets and experimental measurements for arbitrary ENH-UPT diameter, selectable bearing loads, and customizable resistive torques (FIGS. 7, 8, 9).

Equation (13) represents the generalized dynamic balance for an ENH-UPT turbine (or an ENH-UPT series configuration).

$${\dot{E}}_{{absorb ,}_{turbine}} = \{ \begin{matrix}( \frac{2 - q}{2} ) {\dot{E}}_{1 ( ω )} + ( \frac{q}{2} ) {\dot{E}}_{1 ( {U}_{∞} )} & 0 < {U}_{∞} \leq {U}_{∞ , b} , 0 < ω \leq {ω}_{b} \\ ( \frac{2 - q}{2} ) {\dot{E}}_{2 ( ω )} + ( \frac{q}{2} ) {\dot{E}}_{2 ( {U}_{∞} )} & {U}_{∞} > {U}_{∞ , b} , {ω}_{b} < ω < {ω}_{0}\end{matrix} \qquad ( 13 )$$

Equation (14) defines the averaging constant, q, enabling transition between flow regimes.

$$q = \{ \begin{matrix}1 & Non - zero flow condition , & {U}_{∞} > 0 \\ 2 & Zero - flow condition , & {U}_{∞} = 0\end{matrix} \qquad ( 14 )$$

The total power absorption terms in Eq. (13) are given by Eq's. (15-1) through (15-4).

$${\dot{E}}_{1 ( ω )} = ( 2 N - 1 ) β ( \frac{ρ}{{ρ}_{r e f}} ) {( \frac{{R}_{0}}{{R}_{0 r e f}} )}^{2} \frac{{ω}^{3}}{{ω}_{b}} \qquad ( 15 - 1 )$$

$${\dot{E}}_{2 ( ω )} = ( 2 N - 1 ) β ( \frac{ρ}{{ρ}_{r e f}} ) {( \frac{{R}_{0}}{{R}_{0 , ref}} )}^{2} {{ω}_{b}^{2} ( \frac{{ω}_{0} - ω}{{ω}_{0} - {ω}_{b}} )}^{3} \qquad ( 15 - 2 )$$

$${\dot{E}}_{1 ( {U}_{∞} )} = \frac{( 2 N - 1 ) β {λ}_{b}^{2}}{{R}_{0}^{2}} ( \frac{ρ}{{ρ}_{r e f}} ) {( \frac{{R}_{0}}{{R}_{0 , ref}} )}^{2} ( \frac{{U}_{∞}^{3}}{{U}_{∞ , b}} ) \qquad ( 15 - 3 )$$

$${\dot{E}}_{2 ( {U}_{∞} )} = \frac{( 2 N - 1 ) β {λ}_{b}^{2}}{{R}_{0}^{2}} ( \frac{ρ}{{ρ}_{r e f}} ) {( \frac{{R}_{0}}{{R}_{0 , ref}} )}^{2} ( {U}_{∞ , b}^{2} ) \qquad ( 15 - 4 )$$

In all expressions, (R₀) denotes ENH-UPT rotor radius. Subscript “ref” refers to reference values obtained from the ENH-UPT prototype tested in air at ambient pressure of 96,000 Pa. The reference density is

$$( {ρ}_{r e f} = 0.99 \frac{k g}{{m}^{3}} ) ,$$

and the reference balanced torque is (T_{b,ref}=3.0 N·m). The fluid density of the new operating environment is (ρ), and (U_{∞}) is the free-stream flow velocity incident on the ENH-UPT array. The post-interaction flow velocity at balanced operation is denoted (U_{∞,b}), associated with balanced angular speed (ω_{b}=T_{b}/β). For the reference prototype, the balanced angular speed (ω_{b,ref}=1873 rad/sec) corresponds to reference ambient flow condition (U_{∞,b,ref}=44.5 m/sec) and defines the reference tip-speed ratio.

The parameter (N) identifies the number of ENH-UPT turbines connected in series with 3.3 percent spacing than rotor diameter. The balanced rotational speed (ω_{b}) for any scale or configuration is obtained from Eq. (16).

$$β = \{ \begin{matrix}\frac{{T}_{b}}{{ω}_{b}} \approx \frac{{T}_{b , ref}}{{ω}_{b , ref}} & Non - zero flow condition , & {U}_{∞} > 0 \\ \frac{{T}_{b}^{0}}{{ω}_{b}} \approx \frac{{T}_{b , ref}^{0}}{{ω}_{b , ref}} & Zero - flow condition , & {U}_{∞} = 0\end{matrix} \qquad ( 16 )$$

The slope (β) in the linear torque-speed relation defines the resistive torque due to bearings or a generator load. Two formulations are provided:
Eq. (17-1): Constant bearings (identical to 6203-2RS bearings used on the prototype).
Eq. (17-2): Similarity-scaled bearings or arbitrary resistive loads for different turbine scales and fluid environments.

$${T}_{b} = \{ \begin{matrix}{T}_{b , ref} & Non - zero flow condition , & {U}_{∞} > 0 \\ {T}_{b , ref}^{0} & Zero - flow condition , & {U}_{∞} = 0\end{matrix} \qquad ( 17 - 1 )$$

$${T}_{b} = \{ \begin{matrix}{T}_{b , ref} ( \frac{ρ}{{ρ}_{r e f}} ) {( \frac{{R}_{0}}{{R}_{0 , ref}} )}^{2} & Non - zero flow condition , & {U}_{∞} > 0 \\ {T}_{b , ref}^{0} ( \frac{ρ}{{ρ}_{r e f}} ) {( \frac{{R}_{0}}{{R}_{0 , ref}} )}^{2} & Zero - flow condition , & {U}_{∞} = 0\end{matrix} \qquad ( 17 - 2 )$$

The parameters (T_{b,ref}=3.0) and

$$( {T}_{b , ref}^{0} = 3. N . m )$$

represent the maximum available torques of the ENH-UPT at non-zero and zero flow conditions, respectively, and may be obtained from high-accuracy CFD simulations. After surface coating, the average external blade roughness of the ENH-UPT prototype was below 0.05 mm, supporting high-fidelity CFD predictions.

The balanced tip-speed ratio is defined as (λ_{b}=R₀ω_{b}/U_{∞,b}). For ENH-UPT rotational speeds in the range indicated experimentally, the balanced velocity (U_{∞,b}) can be analytically approximated using Eq. (18).

$${U}_{∞ , b} = ( \frac{ρ}{{ρ}_{r e f}} ) {( \frac{{R}_{0}}{{R}_{0 , ref}} )}^{2} {( \frac{{ω}_{b}}{{ω}_{b , ref}} )}^{\frac{2}{3}} {U}_{∞ , b , r e f} 0 < ω \leq {ω}_{0} \qquad ( 18 )$$

The runaway speed (ω₀), corresponding to zero turbine torque, is approximated using Eq. (19). The reference runaway speed (ω_{0,ref}=1915 rad/sec) was measured for the prototype in quiescent air.

$${ω}_{0} = ( \frac{{ω}_{0 , ref}}{{ω}_{b , ref}} ) {ω}_{b} \qquad ( 19 )$$

9.1. Extension to Power Extraction with a Generator

For ENH-UPT turbines connected to a generator—while maintaining resistive torque equivalent to similarity-scaled bearings—the positive torque of rotor on the shaft is determined by Eq. (20).

$$T = \frac{{\dot{E}}_{{absorb ,}_{turbine}}}{ω} \qquad ( 20 )$$

For non-zero flow conditions, the corresponding power coefficient is determined from Eq. (21). These relations allow rapid estimation of generator-integrated power extraction across scales and operating regimes.

$${C}_{p} = \frac{{\dot{E}}_{{absorb ,}_{turbine}}}{0.5 ρ {U}_{∞}^{3} A} \qquad ( 21 )$$

### B. Analytical Support for CFD and Experimental Data

The generalized analytical formulation (Eq's. 13-21) accurately describes the kinematics and dynamics of ENH-UPT turbines from small prototypes to very large utility-scale machines. Two dynamic conditions were evaluated:

### Dynamic Condition 1—Constant Bearings:

Identical bearing load as the reference prototype (6203-2RS). Eq. (17-1).

### Dynamic Condition 2—Similarity-Scaled Bearings:

Resistive loads scaled with turbine size and fluid properties. Eq. (17-2).

FIG. 7 presents balanced angular speed of ENH-UPT turbine under non-zero flow. ENH-UPT turbine accelerates with increasing free-stream velocity until its torque output falls below the resistive torque. For constant bearings, the balanced angular speed remains nearly constant across scales. For similarity-scaled bearings, balanced angular speeds diverge with scale, as expected. Analytical predictions in FIG. 8 show agreement with CFD simulation data in relation to the data of FIG. 7.

FIG. 9 illustrates torque-speed relations under zero-flow conditions. The linear torque-path trajectory in FIG. 9 determines the generator torque optimized for ENH-UPT rotor. Intersection of the linear torque-path trajectory with CFD data determines optimum resistive torque of rotor during power extraction with a generator. The peak of torque curves, the point (ω_{b}, T_{b}) in the FIG. 9, illustrates the optimum power extraction rate of order 5.6 kW for the ENH-UPT rotor. Larger ENH-UPT turbines exhibit significantly higher balanced torque, indicating substantially greater available power. The analytical curves closely match CFD simulations for the prototype at zero-flow, confirming validity of Eq's. (13)-(21).

NOMENCLATURE AND REFERENCES

Nomenclature

| | |
|---|---|
| a | Empirical constant |
| A_{turbine} | Turbine frontal area (m²) |
| b | Empirical constant for UPT |
| b | Determines a parameter when rotational speed of ENH-UPT is balanced |
| c | Empirical constant |
| Cₚ | Power coefficient of turbine |
| d | Empirical constant |
| dX | Incremental length of a stream tube in global coordinate system (m) |

${\dot{E}}_{{absorb ,}_{turbine}} Power absorption of turbine ( Watts )$

| | |
|---|---|
| Ė_{friction} | Frictional resistive power of spindle shaft (Watts) |
| Ėₚᵣₒₚₑₗₗₑᵣ | Aerodynamic resistive power of propeller (Watts) |
| Ėᵣₑₛᵢₛₜᵢᵥₑ | Total resistive power including aerodynamic resistive power of propeller and |
| | frictional resistive power of spindle shaft (Watts) |
| i | Stream tube index |
| N | Number of ENH-UPT turbines in series configuration |
| P_{abs} | Local absolute pressure in rotation domain (Pa) |
| P_{reference} | Reference absolute pressure in rotation domain (mean pressure around turbine) |
| (Pa) | |
| ${∇}_{x} {p}_{{dynamic ,}_{ignored}}$ | Ignored gradient of dynamic pressure gradient due to fluid transfer with moving boundary (Pa/m) |
| R₀ | Radius of ENH-UPT turbine (m) |
| Sᵢ | i-th component of momentum source term for stream tube element i |

${( {s}_{{i}_{x}} )}_{RRF} Volumetric x - component of momentum source term for correction$
${( {s}_{{i}_{y}} )}_{RRF} Volumetric y - component of momentum source term for correction$
${( {s}_{{i}_{z}} )}_{RRF} Volumetric z - component of momentum source term for correction$

| | |
|---|---|
| T₀ | Resistive torque on shaft of ENH-UPT turbines at non-zero flow condition (N · m) |
| T_{turbine} | Torque of turbine during power absorption (N · m) |

${T}_{b}^{0} Resistive torque on shaft of ENH - UPT turbines at zero flow condition ( N \cdot m )$

| | |
|---|---|
| T_{friction} | Frictional torque of spindle (N · m) |
| Tₚᵣₒₚₑₗₗₑᵣ | Resistive torque of propeller (N · m) |
| U | Wind velocity magnitude including swirling component (m/s) |
| U_{y} | Axial velocity of fluid in y-direction (y is rotation axis) (m/s) |
| u_{θ} | Tangential velocity magnitude of the fluid flow (m/s) |
| Uᵣₑₗ | Triangular relative velocities of fluid flow corresponding to the lost |
| | dynamic pressure (m/s) |
| | Free-stream velocity of fluid (m/s) |
| U_{∞,b} | Free-stream velocity when rotational speed of ENH-UPT is balanced (m/s) |
| Xᵢ | Turbine global coordinate vector corresponding to stream tube i (m) |

Greek symbols

| | |
|---|---|
| ρ | Air density (kg/m³) |
| ρ_{ref} | Reference density when ENH-UPT prototype is tested in air (kg/m³) |
| β | Slope of linear T₀-ω curve (N · m/(rad/s)) |
| d∀ | Volume of stream tube (m³) |
| λ_{b} | Tip-speed ratio for which rotational speed of ENH-UPT is balanced |
| ω | Angular velocity of turbine and propeller or spindle shaft (rad/s) |
| ω | Angular speed vector for turbine walls (rad/s) |
| ω_{b} | balanced speed for ENH-UPT turbines (rad/s) |
| ω₀ | Runaway speed for ENH-UPT turbines (rad/s) |
| ω_{0,ref} | Runaway speed for reference (prototype size in air) ENH-UPT turbines (rad/s) |

### REFERENCES

1— Umar, D. A., et al. “Design and optimization of a small-scale horizontal axis wind turbine blade for energy harvesting at low wind profile areas.” Energies, 15, 3033 (2022). DOI: 10.3390/en15093033.

1. A pressure-driven axial turbine system, comprising: a rotor assembly including one or more blade rows arranged about a rotational axis; wherein the blade rows define a blade geometry selected from an Ultra-Power Turbine (UPT) configuration or an Enhanced-Ultra-Power (ENH-UPT) configuration, each geometry being defined by predetermined blade curvature, pitch distribution, and pressure-loading characteristics; wherein interaction between the blade geometry and a surrounding fluid produces a pressure gradient sufficient to initiate and sustain rotation of the (ENH-UPT) rotor assembly in the absence of externally imposed bulk flow; and wherein the rotor assembly exhibits a measured power coefficient substantially greater than 1.0, determined from absorbed fluid power relative to incident flow kinetic power.

2. The turbine system of claim 1, wherein the blade geometry is configured to locally concentrate static pressure within blade rows to increase torque through pressure-driven flow redistribution.

3. The turbine system of claim 1, wherein the rotor assembly comprises two or more axial blade rows arranged to generate a cyclic pressure drop between adjacent rows, thereby amplifying absorbed power relative to a single-row configuration.

4. The turbine system of claim 1, wherein the (ENH-UPT) rotor assembly initiates and maintains rotation under ambient conditions characterized by negligible or zero measurable free-stream flow velocity.

5. The turbine system of claim 1, wherein rotational behavior, torque, and absorbed power are characterized using electro-mechanical measurement devices, including rotational-speed sensors, torque estimation devices, or calibrated resistive loads, without converting shaft rotation into mechanical or electrical output power.

6. The turbine system of claim 1, wherein rotational speed of the rotor assembly approaches a stable equilibrium due to torque decay associated with pressure redistribution, defining an upper operational speed limit.

7. A method for characterizing a pressure-driven axial turbine, comprising: providing a rotor assembly having blade geometry corresponding to an Ultra-Power Turbine (UPT) or an Enhanced-Ultra-Power (ENH-UPT) configuration; exposing the rotor assembly to a surrounding fluid environment; allowing the rotor assembly to rotate in response to pressure gradients generated by the blade geometry; measuring rotational speed, torque, or absorbed power using electro-mechanical instrumentation; and determining a power coefficient greater than 1.0 based on absorbed fluid power relative to incident flow kinetic power.

8. The method of claim 7, further comprising validating measured rotational and power-absorption behavior using a computational fluid dynamics (CFD) model incorporating momentum-equation correction terms for a rotating fluid domain.
